(19) United States
(12) Patent Application Publication
(10) Pub. No.: US 2005/0264803 A1
(43) Pub. Date: Dec. 1, 2005

(54) Optical apparatus for measuring absorption and fluorescence or scattering properties of a sample

(76) Inventor: Gareth Jones, Warrington (GB)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/521,484

(22) PCT Filed: Jul. 21, 2003
(86) PCT No.: PCT/GB03/03145

§ 371 Date: Jan. 20, 2005

(30) Foreign Application Priority Data
Jul. 20, 2002 (GB) 0216934.0

(51) Int. Cl. G01N 21/00

(52) U.S. Cl. 356/240.1

(57) ABSTRACT

An optical apparatus comprising a sample holding means (11), a detector (2) and first and second light selection means (5, 6, 15), the sample holding means being provided with a window to receive incident light (3) from a light source, the first light selection means (5) being arranged to allow light that passes from the sample holding means in a direction substantially parallel to the direction of the incident light to pass to the detector, and the second light selection means (6, 15) being arranged to allow light that is emitted from the sample holding means in a direction substantially transverse to the direction of the incident light to pass to the detector.

The present invention relates to an optical apparatus, and particularly though not exclusively to an apparatus suitable for measuring optical properties of a sample.

Measuring optical properties of a sample is a common way of identifying or characterising a sample. Optical properties that are commonly measured include absorbance, scattering and fluorescence.

Absorbance is conventionally measured by directing light into a sample held in a cell, and detecting the amount of light which is transmitted directly through the sample. Typically the measurement is normalised by detecting the amount of light which is transmitted directly through a cell containing no sample.

Florescence is conventionally measured by directing light of a suitable excitation wavelength into a sample held in a cell, and detecting fluorescent light emitted in transverse directions from the sample. In a known prior art arrangement a single detector is placed adjacent the cell. This is referred to as an L-format arrangement. In an alternative prior art arrangement detectors are placed on either side of the cell. This is referred to as a T-format arrangement. A wavelengtih dependent optical filter may be used to ensure that only fluorescent light is incident upon the detector, and not scattered or transmitted light (the fluorescence wavelength is longer than the excitation wavelength).

Scattering is conventionally measured by directing light of a suitable wavelength into a sample held in a cell, and detecting light scattered in transverse directions from the sample. An L-format arrangement or a T-format arrangement of detectors may be used. A wavelength dependent optical filter may be used to ensure that only scattered light, and not fluorescent light, is incident upon the detector.

Optical apparatuses are known which can measure absorption or which can measure both florescence and scattering. Difficulties arise however, when it is necessary to measure both the absorption and scattering or florescence of a particular sample. With conventional sample cells, such as a stocked-flow cell, continuous flow cell, pressure cell (jump or continuous), temperature jump cell, moving the sample between apparatuses can be problematical.

It is all object of the present invention to obviate or mitigate the above difficulties.

According to the invention there is provided an optical apparatus comprising a sample holding means, a detector and first and second light selection means, the sample holding means being arranged to receive incident light from a light source, the first light selection means being arranged to selectively allow light that passes from the sample holding means in a direction substantially parallel to the direction of the incident light to pass to the detector, and the second light selection means being arranged to selectively allow light that is emitted from the sample holding means in a direction substantially transverse to the direction of the incident light to pass to the detector.

The invention is advantageous because it allows the measurement of absorbance and of fluorescence or scattering in a single apparatus, and moreover using a single detector.

Preferably, the first light selection means comprises a shutter located between the sample holding means and the detector, the shutter being moveable between a first position in which the light that is substantially parallel to the incident light passes through the shutter to the detector, and a second position in which the light that is substantially parallel to the incident light is prevented from passing to the detector.

Preferably, the shutter is provided with a reflective surface arranged such that when the shutter is in the second position the light that is substantially parallel to the incident light is reflected from the shutter.

The shutter may be arranged to reflect the light back into the sample holder.

Alternatively, the shutter may be arranged to reflect the light to a second detector or to a light trap.

Preferably, the reflective surface of the shutter is moveable, and may be adjusted to either reflect the light back into the sample holder, or to reflect the light to the second detector or to the light trap. Where a second detector is used this allows the simultaneous measurement of absorbance and of fluorescence (or scattering).

The second light selection means, may comprise one or more light guides, which may be provided with light guide shutters moveable from a first configuration in which light is allowed to enter the one or more light guides, and a second configuration in which light is substantially prevented from entering the one or more light guides.

The one or more light guides, preferably comprise one or more pentaprisms, but may for instance comprise one or more fibre optic cables.

Preferably operation means are provided to operate the first and second light selection means simultaneously such that when the first light selection means is adjusted to pass light to the detector the second light selector means is adjusted to prevent passage of light to the detector and vice versa.

The operation means comprises a mechanical connection.

The apparatus is provided with one or more wavelength dependent optical filters which may be used to selectively transmit to the detector light at the wavelength of the incident light or light at a fluorescence wavelength.

Suitably, the one or more wavelength dependent optical filters may be mounted in a holder which may be connected to the operation means, such that movement of the shutter and the light guide shutters also moves the holder, thereby positioning an appropriate wavelength dependent optical filter over the detector.

The holder may be provided with an opening which does not contain a wavelength dependent optical filter.

The detector may be any suitable, conventional detector such as a photo-multiplier tube.

The sample holding means may comprise a housing dimensioned to receive a cuvette. Areas of upper and lower surfaces of the housing are opaque such that light travelling in a direction which is not substantially parallel to the direction of the incident light is prevented from passing via the first light selection means to the detector.

A specific embodiment of the invention will now be described by way of example only, with reference to the accompanying figures, in which:

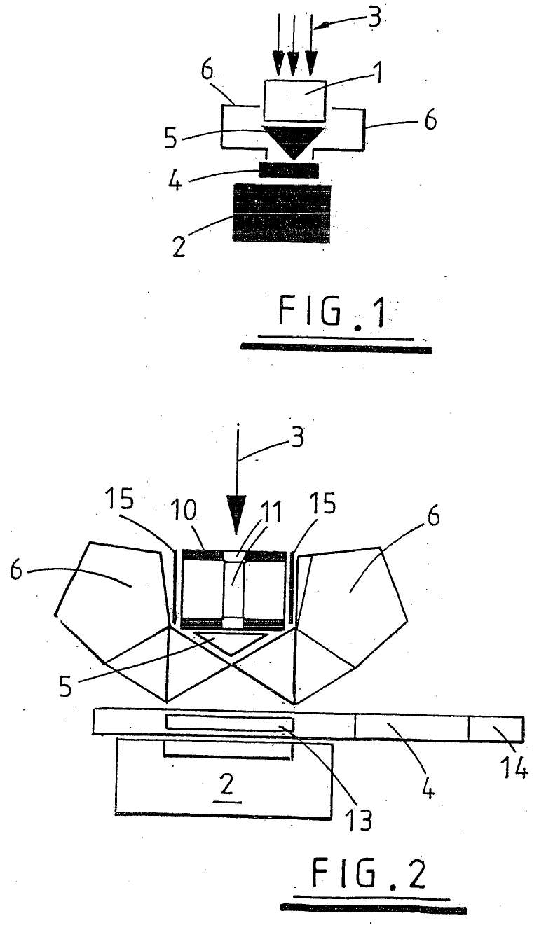

FIG. 1 is a schematic illustration of an optical apparatus which embodies the invention;

FIG. 2 is a more detailed schematic illustration of the embodiment shown in FIG. 1;

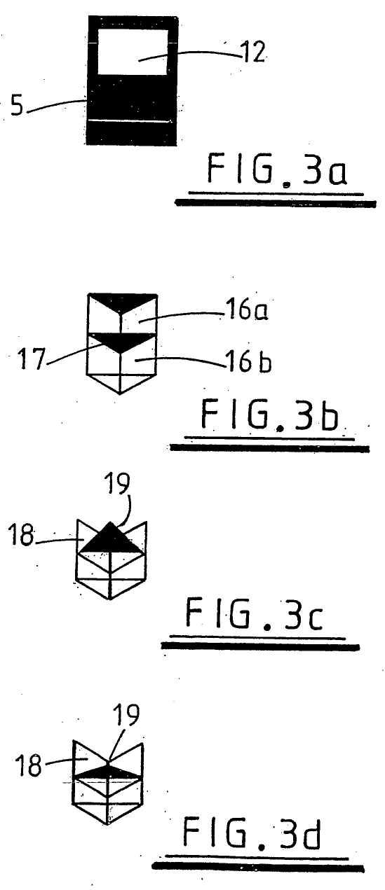

FIG. 3 is a series of schematic illustrations of shutters which may form part of the apparatus shown in FIGS. 1 and 2.

Referring to FIG. 1, a cell 1 containing a sample is located vertically above a detector 2. A light source, for example a laser (not shown) generates a beam of light 3 which passes vertically downwards into the cell 1. An aperture 4 is located between the cell 1 and the detector 2. A moveable shutter 5 is located between the cell 1 and the aperture 4. Light guiding means 6 are provided at sides of the cell 1 and are arranged to guide light emitted from sides of the cell 1 via the aperture 4 to the detector 2.

In use, when absorbance is to be measured the shutter 5 is opened. This allows light 3 which has passed through the cell 1 to travel through the aperture 4 and be incident upon the detector 2.

When florescence is to be measured the shutter 5 is closed, thereby preventing light which has passed directly through the cell 1 from being incident upon the detector 2. Florescence which is emitted transversely from the cell 1 is collected by the light guides 6 and directed through the aperture 4 and onto the detector 2.

When scattering is to be measured the shutter 5 is closed. Scattered light is collected by the light guides 6 and passed through the aperture 4 to the detector 2.

FIG. 2 shows the embodiment of the invention in more detail. Referring to FIG. 2, the cell 1 comprises a housing 10 containing a cuvette 11. A sample is held within the cuvette 11. The upper and lower ends and the walls of the cuvette 11 are substantially transparent at wavelengths of interest. An uppermost surface of the housing 10 is substantially opaque, so that incident light 3 is allowed to enter the sample cuvette 11 through the upper end of the cuvette 11 only. A lowermost surface of the housing 10 is similarly opaque so that light cannot pass downwards towards the shutter 5 except through the lower end of the cuvette 11.

One possible configuration of the shutter 5 is shown in FIG. 3a. The shutter 5 comprises a plate into which an opening 12 has been cut. The shutter 5 is located beneath the housing 10 and sample cuvette 11 and is moveable from a first position in which the opening allows light to pass from the sample cuvette 11 to the detector 2, to a second position in which the plate prevents light passing from the sample cuvette 11 to the detector 2.

Referring again to FIG. 2, the aperture 4 and a suitable wavelength dependent optical filter 13 are provided in a housing 14. The housing may be slid from left to right (as viewed in FIG. 2) to allow either the filter 13 or the aperture 4 to be located above the detector 2. The wavelength dependent optical filter 13 may be selected to prevent light at the incident wavelength passing to the detector 2, whilst allowing transmission of florescent light to the detector 2. Alternatively, the wavelength dependent optical filter may be selected to prevent fluorescent light passing to the detector 2 whilst allowing transmission of light at the incident wavelength to the detector 2.

The light guides 6 comprise pentaprisms located on either side of the sample housing 10. Since side windows of the sample housing 10 are transparent at wavelengths of interest, florescent light emitted by the sample or light scattered by the sample will pass through walls of the sample holder 10, and into the pentaprisms 6. The pentaprisms 6 have reflecting faces which are arranged such that light which passes into the pentaprisms 6 from the sample holder 10 is reflected by the pentaprisms 6 downward towards the detector 2. The pentaprisms 6 have faces 6a which are cut at an angle. The angle is selected so that as much light as possible passes from the sample holder 10 into the pentaprisms 6 (if the faces were not cut at an angle a significant proportion of the light would be reflected by the faces, and would thus not be detected).

When florescent light is to be detected, the wavelength dependent optical filter 13 may be positioned over the detector 2 using the housing 14, so that florescent light is transmitted to the detector 2 but light at the incident wavelength is not transmitted to the detector 2. Where the apparatus is used to measure scattering (i.e. turbidity measurements) the wavelength dependent optical filter 13 may be positioned over the detector using the housing 14, so that fluorescent light is blocked from being incident upon the detector. If the sample is not fluorescent, or if the wavelength of the incident light is such that it will not induce fluorescence, then a wavelength dependent optical filter 13 is not required, and the aperture 4 may be used instead.

As previously described, during measurement of florescence or scattering the shutter 5 is positioned to prevent light which has passed directly through the sample cuvette 11 from being incident upon the detector 2. The uppermost surface of the shutter 5 may be reflective, to reflect light which has passed through the sample cuvette 11 back into the sample cuvette 11, thereby providing increased illumination. This is advantageous because it increases the amount of florescent light or scattered light that may be detected.

Shutters 15 are provided between the sample holder 10 and the pentaprisms 6. The shutters are moved to an open position when florescence or scattering is to be measured, and are moved to a closed position (as shown in FIG. 2) when absorbence is to be measured.

The detector 2 comprises a photo-multiplier tube with variable gain. When the photo-multiplier tube is used to measure fluorescence or scattering, the amount of light incident upon the detector may be small. When this is the case the gain of the photo-multiplier tube may be set to its maximum. When the photo-multiplier tube is used to measure absorbance (i.e. the amount of light transmitted directly through the sample) the amount of light incident upon the detector may be substantially greater. When this is the case the gain of the photo-multiplier tube is reduced accordingly. The gain of the photo-multiplier tube may be adjusted by turning on or off amplification stages (dynodes) of the photo-multiplier tube, or adjusting the high tension voltage that is applied to the photo-multiplier tube.

An alternative configuration of the shutter 5 is shown in FIG. 3b. The shutter 5 comprises a prism 16 which is separated into two halves by an opaque layer 17. The first half 16a of the prism is provided with a reflective layer. Referring to FIG. 2, the reflective layer is provided on the surface of the prism 16 which is closest to the sample holder 10. When the first half 16a of the prism 16 is located beneath the sample holder 10, the prism 16 reflects light transmitted by the sample directly back into the sample holder 10. The second half 16b of the prism 16 is not provided with a reflective layer. When the second half 16b of the prism 16 is located beneath the sample holder 10, the prism transmits to the detector 2 light which has been transmitted by the sample. The prism 16 is moveable between first and second positions in which either the first half 16a or the second half 16b of the prism 16 is located beneath the sample holder 10.

A further alternative configuration, of the shutter 5 is shown in FIGS. 3c and 3d. The shutter 5 comprises a prism 18 having a first half 18a provided with a moveable reflecting face 19, and a second half 18b which is not provided with a reflective layer. When the first half 18a of the prism 18 is located beneath the sample holder 10, the reflecting face 19 reflects light away from the detector 2. When the reflecting face 19 is in a first position (horizontal in FIG. 2), light is reflected directly back into the sample holder 10. When the reflecting face 19 is in a second position (at an angle of 45 degrees to the horizontal), light which has been transmitted by the sample is directed horizontally away from the detector 2. The light may be collected in a light trap. Alternatively, the light may be passed to a second detector (not shown), thereby allowing simultaneous measurement of absorbance and scattering or fluorescence. This may be advantageous when the absorbance and scattering or fluorescence are being measured as a function of time.

It is possible to obtain ‘near simultaneous’ measurements of absorbance and measurements of scattering or fluorescence using the apparatus with the single detector 2, by repeatedly moving the shutters 5, 15 rapidly between the absorbance measurement configuration and the scattering or fluorescence measurement configuration. Provided that the movement between configurations takes place at a rate which is significantly faster than the rate of change of the absorbance or scattering (or fluorescence) the measurements obtained will not be compromised by the movement of the shutters 5, 15.

The apparatus is advantageous because it allows measurement of absorbance and measurement of scattering or fluorescence using a single detector and without the need to move a sample. A further advantage of the apparatus is that it allows simultaneous measurement of absorbance and measurement of scattering or fluorescence, thereby allowing associated time-resolved measurements of those properties. The shutters 5, 15 are mechanically connected together by a simple cross-member filament, to allow them to be moved simultaneously by a single manual or automated operation.

The shutters 5, 15 may, instead of being mechanically connected, be separately driven for example by electric motors (not shown). The electric motors may be controlled by a suitable controller such that they are moved simultaneously.

The housing 14 may be mechanically connected to the shutters 5, 15 such that an appropriate filter 13 or the aperture 4 is positioned above the detector 2 when the shutters 5, 15 are moved.

Although the light guides 6 are shown in FIG. 2 as being pentaprisms, other suitable forms of light guide may be used, for example optical fibres. A single light guide 6 may be used instead of two light guides 6, although this will reduce the amount of light that is coupled to the detector 2.

The wavelength dependent optical filters 13 may be any suitable known filters, for example cut on/off filters, interference filters, dichroic filters, etc.

1. An optical apparatus comprising a sample holding means, a detector and first and second light selection means, the sample holding means being arranged to receive incident light from a light source, the first light selection means being arranged to selectively allow light that passes from the sample holding means in a direction substantially parallel to the direction of the incident light to pass to the detector, and the second light selection means being arranged to selectively allow light that is emitted from the sample holding means in a direction substantially transverse to the direction of the incident light to pass to the detector, wherein the first and second light selection means are operable simultaneously such that when the first light selection means is adjusted to pass light to the detector, the second light selection means is adjusted to prevent passage of any light to the detector, and vice versa.

2. An optical apparatus according to claim 1, wherein the first light selection means comprises a shutter located between the sample holding means and the detector, the shutter being moveable between a first position in which the light that is substantially parallel to the incident light passes through the shutter to the detector, and a second position in which the light that is substantially parallel to the incident light is prevented from passing to the detector.

3. An optical apparatus according to claim 2, wherein the shutter is provided with a reflective surface arranged such that when the is in the second position the light that is substantially parallel to the incident light is reflected from the shutter.

4. An optical apparatus according to claim 3, wherein the shutter is arranged to reflect the light back into the sample holder.

5. An optical apparatus according to claim 3, wherein the shutter is arranged to reflect the light to a second detector or to a light trap.

6. An optical apparatus according to claims 4, wherein the reflective surface of the shutter is moveable and may be adjusted to either reflect the light back into the sample holder, or to reflect the light to a second detector or to a light trap.

7. An optical apparatus according claim 2, wherein the second light selection means comprises one or more light guides.

8. An optical apparatus according to claim 7, wherein the one or more light guides are provided with light guide shutters moveable from a first configuration in which light is allowed to enter the one or more light guides, and a second configuration in which light is substantially prevented from entering the one or more light guides.

9. An optical apparatus according to claim 8, wherein the one or more light guides comprise one or more pentaprisms.

10. An optical apparatus according to claim 8, wherein the one or more light guides comprise one or more fibre optic cables.

11. An optical apparatus according to claim 8, wherein the shutter and the light guide shutters are provided with operation means which allow them to be operated simultaneously, such that as the shutter is moved from a first position to a second position, thereby preventing light substantially parallel to the incident light from passing to the detector, the light guide shutters move from their second position to their first position, thereby allowing light substantially transverse to the incident light to pass to the detector, and vice versa.

12. An optical apparatus according to claim 11, wherein the operation means comprises a mechanical connection.

13. An optical apparatus according to claim 1, wherein the apparatus is provided with one or more wavelength dependent optical filters which may be used to selectively transmit to the detector light at the wavelength of the incident light or light at a fluorescence wavelength.

14. An optical apparatus according to claim 13, wherein the shutter and the light guide shutters are provided with operation means which allow them to be operated simultaneously, such that as the shutter is moved from a first position to a second position, thereby preventing light substantially parallel to the incident light from passing to the detector, the light guide shutters move from their second position to their first position, thereby allowing light substantially transverse to the incident light to pass to the detector, and vice versa, and wherein the one or more wavelength dependent optical filters are mounted in a holder which may be connected to the operation means, such that movement of the shutter and the light guide shutters also moves the holder, thereby positioning an appropriate wavelength dependent optical filter over the detector.

15. An optical apparatus according to claim 14, wherein the holder is provided with an opening which does not contain a wavelength dependent optical filter.

16. An optical apparatus according to claim 1, wherein the detector is a photo-multiplier tube.

17. An optical apparatus according to claim 1, wherein the sample holding means comprises a housing dimensioned to receive a cuvette.

18. An optical apparatus according to claim 17, wherein areas of upper and lower surfaces of the housing are opaque such that light travelling in a direction which is not substantially parallel to the direction of the incident light is prevented from passing via the first light selection means to the detector.

19. An optical apparatus according to claim 1, wherein the second light selection means comprises one or more light guides.

20. (canceled)
